(19) United States
(12) Patent Application Publication
(10) Pub. No.: US 2020/0265133 A1
(43) Pub. Date: Aug. 20, 2020

(54) Authentication Using Vaporization Device

(71) Applicant: Visa International Service Association, San Francisco, CA (US)

(72) Inventor: Gaurav Srikant Mokhasi, Bengaluru (IN)

(21) Appl. No.: 16/278,343

(22) Filed: Feb. 18, 2019

(51) Int. Cl. G06F 21/35; G06F 21/32; A24F 47/00; G06Q 20/40

(52) U.S. Cl. CPC G06F 21/35; G06Q 20/4012; A24F 47/008; G06F 21/32

(57) ABSTRACT

Provided is an authentication method, including detecting, with at least one sensor arranged in a vaporization device, a plurality of breaths inhaled from and/or exhaled into the vaporization device, the plurality of breaths in at least one pattern, and communicating, from the vaporization device, authentication data representing the at least one pattern to an authentication system.

### BACKGROUND

### Field

The present disclosure relates to authentication and, in particular, non-limiting embodiments or aspects, to a vaporization device and an authentication method using a vaporization device.

### Technical Background

Vaporization devices have emerged as a popular alternative to smoking. Modern vaporization devices involve an electrical current that passes through a chamber, allowing for the controlled heating of a substance, thereby minimizing combustion and reducing the consumption of undesired chemicals. Vaporization devices require a certain degree of handling in use, occupying the user's hands and precluding them from actively engaging in extraneous activities. Some vaporization devices involve more handling than a traditional cigarette because they require the pressing of a button to activate a heating element and produce the vapor for inhalation. This complicates the user's ability to use the vaporizer while simultaneously performing day-to-day activities. For example, a user might struggle to access their wallet or use their phone while using a vaporizer. Compounding this problem, existing means of authentication typically require physically inputting a Personal Identification Number (PIN) or other credential to a payment transaction device. Aside from being cumbersome, the inputting of a PIN typically occurs in plain view, resulting in the risk of a third-party obtaining unauthorized access to the user's PIN.

Furthermore, many vaporizers utilize replaceable, pre-filled cartridges that the user replaces separately. If the user consumes an entire cartridge, there is an inevitable delay before they are able to replace the cartridge and continue using the vaporizer. Users are more likely to remember that they need to purchase additional cartridges when using the vaporizer, while at least one hand is occupied by the vaporizer itself. However, existing vaporization devices lack the ability to authenticate the identity of the user, rendering the purchase of additional cartridges from the vaporization device itself difficult.

Therefore, there is a need for vaporization devices and methods that facilitate the authentication of a user.

### SUMMARY

According to a non-limiting embodiment, provided is a method of authentication using a vaporization device, including: detecting, with at least one sensor arranged in a vaporization device, a plurality of breaths inhaled from and/or exhaled into the vaporization device, the plurality of breaths in at least one pattern; and communicating, from the vaporization device, authentication data representing the at least one pattern to at least one of a merchant system and a transaction processing system.

In some non-limiting embodiments or aspects, the authentication method further includes receiving, with a controller arranged in the vaporization device, data from at least one of the merchant system and the transaction processing system; and prompting, with an indicator arranged on the vaporization device, a user of the vaporization device to input the plurality of breaths to the vaporization device in response to receiving the data from the at least one of the merchant system and the transaction processing system.

In some non-limiting embodiments or aspects, the authentication method further includes: receiving, with a controller arranged in the vaporization device, data from at least one of the merchant system and the transaction processing system; initiating, with the controller, an authentication mode of the vaporization device; and in response to initiating the authentication mode, detecting the plurality of breaths. In some non-limiting embodiments or aspects, the authentication method further includes: receiving, with a controller arranged in the vaporization device, at least one biometric input from the user; and determining, with the controller, that the user is not authenticated based at least partially on the at least one biometric input, wherein the user is prompted to provide the plurality of breaths in response to determining that the user is not authenticated. In some non-limiting embodiments or aspects, the biometric input comprises at least one of the following: a pattern of use of the vaporization device, a scan of the user's lips, a scan of the user's tongue, or any combination thereof. In some non-limiting embodiments or aspects, the authentication method further includes: determining, with a controller arranged in the vaporization device, that the at least one pattern matches at least one authentication pattern associated with the user or a payment device; and generating, with the controller, the authentication data in response to determining that the at least one pattern matches the at least one authentication pattern. In some non-limiting embodiments or aspects, the authentication data is communicated to the at least one of the merchant system and the transaction processing system via a mobile device in localized communication with the vaporization device.

According to another non-limiting embodiment, provided is a vaporization device, including a mouthpiece; at least one sensor configured to detect a plurality of breaths inhaled from and/or exhaled into the mouthpiece; at least one controller in communication with the at least one sensor, the at least one controller programmed and/or configured to: communicate with a merchant system and/or a transaction processing system; and based on data received from the merchant system and/or the transaction processing system, prompt a user of the vaporization device to input the plurality of breaths to the vaporization device.

In some non-limiting embodiments or aspects, the vaporization device further includes at least one indicator, wherein the user is prompted with the at least one indicator. In some non-limiting embodiments or aspects, the indicator comprises at least one of the following: a visual indicator arranged on the vaporization device, a mobile device associated with the user, a graphical user interface on a mobile device associated with the user, or any combination thereof. In some non-limiting embodiments or aspects, the vaporization device further includes at least one controller, further programmed and/or configured to: in response to receiving data from the at least one of the merchant system and the transaction processing system, initiating an authentication mode. In some non-limiting embodiments or aspects, the at least one controller is further programmed and/or configured to: detect the plurality of breaths in response to initiating the authentication mode.

According to another non-limiting embodiment, provided is an authentication method, including: detecting, with at least one sensor arranged in a vaporization device, a plurality of breaths from a user, the plurality of breaths comprising at least one pattern; determining, with at least one processor, that the at least one pattern matches at least one authentication pattern associated with the user or a payment device; and in response to determining that the at least one pattern matches the at least one authentication pattern, authenticating, with at least one processor, a transaction between the user and a merchant.

In some non-limiting embodiments or aspects, the authentication method further includes: receiving, from a merchant system, a request to conduct the transaction; receiving, from the vaporization device, at least one biometric input associated with the user; determining, with at least one processor, that the transaction or the user is not authenticated based on the at least one biometric input; and in response to determining that the transaction or the user is not authenticated based on the at least one biometric input, prompting, with at least one processor, the user to provide the plurality of breaths. In some non-limiting embodiments or aspects, the authentication method further includes: the biometric input comprises at least one of the following: a pattern of use of the vaporization device, a scan of the user's lips, a scan of the user's tongue, or any combination thereof.

In some non-limiting embodiments or aspects, the plurality of breaths comprise at least one of inhalation and exhalation. In some non-limiting embodiments or aspects, the at least one pattern comprises a series of breaths and pauses. In some non-limiting embodiments or aspects, the authentication method further includes: deriving a numerical value from the at least one pattern. In some non-limiting embodiments or aspects, the numerical value comprises a Personal Identification Number (PIN) associated with the user or the payment device. In some non-limiting embodiments or aspects, the numerical value is derived based on counting a timing of the pattern.

According to another non-limiting embodiment or aspect, provided is an authentication method, including: receiving, with at least one processor from a vaporization device, at least one pattern representing a plurality of inputs provided to the vaporization device from a user; determining, with at least one processor, that the at least one pattern matches at least one authentication pattern associated with the user; and in response to determining that the at least one pattern matches the at least one authentication pattern, authenticating, with at least one processor, a transaction between the user and a merchant.

In some non-limiting embodiments or aspects, the plurality of inputs comprise a plurality of tactile inputs received by a sensor arranged on the vaporization device. In some non-limiting embodiments or aspects, the sensor comprises at least one of a button and a motorized projection.

According to another non-limiting embodiment, provided is an authentication method, including: detecting, with at least one sensor arranged in a vaporization device, a plurality of inputs in at least one pattern; and communicating, from the vaporization device, authentication data representing the at least one pattern to at least one of a merchant system and a transaction processing system.

In some non-limiting embodiments or aspects, the plurality of inputs comprise a plurality of tactile inputs received by sensor arranged on the vaporization device, the sensor comprising at least one of a button and a motorized projection.

According to another non-limiting embodiment or aspect, provided is a vaporization device, including a mouthpiece; at least one sensor configured to detect a plurality of inputs provided to the mouthpiece; at least one controller in communication with the at least one sensor, the at least one controller programmed and/or configured to: communicate with a merchant system and/or a transaction processing system; and based on data received from the merchant system and/or the transaction processing system, prompt a user of the vaporization device to input the plurality of inputs to the vaporization device.

In some non-limiting embodiments or aspects, vaporization device further includes at least one indicator, wherein the user is prompted with the at least one indicator. In some non-limiting embodiments or aspects, the at least one indicator comprises at least one of the following: a visual indicator arranged on the vaporization device, a mobile device associated with the user, a graphical user interface on a mobile device associated with the user, or any combination thereof. In some non-limiting embodiments or aspects, the plurality of inputs comprise a plurality of tactile inputs, and wherein the sensor comprises at least one of a button and a motorized projection.

Further non-limiting embodiments or aspects are set forth in the following numbered clauses:

Clause 1. An authentication method, including: detecting, with at least one sensor arranged in a vaporization device, a plurality of breaths inhaled from and/or exhaled into the vaporization device, the plurality of breaths in at least one pattern; and communicating, from the vaporization device, authentication data representing the at least one pattern to at least one of a merchant system and a transaction processing system.

Clause 2. The method of clause 1, further including: receiving, with a controller arranged in the vaporization device, data from at least one of the merchant system and the transaction processing system; prompting, with an indicator arranged on the vaporization device, a user of the vaporization device to input the plurality of breaths to the vaporization device in response to receiving the data from the at least one of the merchant system and the transaction processing system.

Clause 3. The method of clauses 1 or 2, further including: receiving, with a controller arranged in the vaporization device, data from at least one of the merchant system and the transaction processing system; initiating, with the controller, an authentication mode of the vaporization device; and in response to initiating the authentication mode, detecting the plurality of breaths.

Clause 4. The method of any of clauses 1-3, further including: receiving, with a controller arranged in the vaporization device, at least one biometric input from the user; and determining, with the controller, that the user is not authenticated based at least partially on the at least one biometric input, wherein the user is prompted to provide the plurality of breaths in response to determining that the user is not authenticated.

Clause 5. The method of any of clauses 1-4, wherein the biometric input comprises at least one of the following: a pattern of use of the vaporization device, a scan of the user's lips, a scan of the user's tongue, or any combination thereof.

Clause 6. The method of any of clauses 1-5, further including: determining, with a controller arranged in the vaporization device, that the at least one pattern matches at least one authentication pattern associated with the user or a payment device; and generating, with the controller, the authentication data in response to determining that the at least one pattern matches the at least one authentication pattern.

Clause 7. The method of any of clauses 1-6, wherein the authentication data is communicated to the at least one of the merchant system and the transaction processing system via a mobile device in localized communication with the vaporization device.

Clause 8. A vaporization device, including: a mouthpiece; at least one sensor configured to detect a plurality of breaths inhaled from and/or exhaled into the mouthpiece; at least one controller in communication with the at least one sensor, the at least one controller programmed and/or configured to: communicate with a merchant system and/or a transaction processing system; and based on data received from the merchant system and/or the transaction processing system, prompt a user of the vaporization device to input the plurality of breaths into the vaporization device.

Clause 9. The vaporization device of clause 8, further including at least one indicator, wherein the user is prompted with the at least one indicator.

Clause 10. The vaporization device of clauses 8 or 9, further wherein at least one indicator comprises at least one of the following: a visual indicator arranged on the vaporization device, a mobile device associated with the user, a graphical user interface on a mobile device associated with the user, or any combination thereof.

Clause 11. The vaporization device of any of clauses 8-10, wherein the at least one controller is further programmed and/or configured to: in response to receiving data from the at least one of the merchant system and the transaction processing system, initiating an authentication mode.

Clause 12. The vaporization device of any of clauses 8-11, wherein the at least one controller is further programmed and/or configured to: detect the plurality of breaths in response to initiating the authentication mode.

Clause 13. An authentication method, including: detecting, with at least one sensor arranged in a vaporization device, a plurality of breaths from a user, the plurality of breaths comprising at least one pattern; determining, with at least one processor, that the at least one pattern matches at least one authentication pattern associated with the user or a payment device; and in response to determining that the at least one pattern matches the at least one authentication pattern, authenticating, with at least one processor, a transaction between the user and a merchant.

Clause 14. The method of clause 13, further including receiving, from a merchant system, a request to conduct the transaction; receiving, from the vaporization device, at least one biometric input associated with the user; determining, with at least one processor, that the transaction or the user is not authenticated based on the at least one biometric input; and in response to determining that the transaction or the user is not authenticated based on the at least one biometric input, prompting, with at least one processor, the user to provide the plurality of breaths.

Clause 15. The method of clauses 13 or 14, wherein the biometric input comprises at least one of the following: a pattern of use of the vaporization device, a scan of the user's lips, a scan of the user's tongue, or any combination thereof.

Clause 16. The method of any of clauses 13-15, wherein the plurality of breaths comprise at least one of inhalation and exhalation.

Clause 17. The method of any of clauses 13-16, wherein the at least one pattern comprises a series of breaths and pauses.

Clause 18. The method of any of clauses 13-17, further comprising deriving a numerical value from the at least one pattern.

Clause 19. The method of any of clauses 13-18, wherein the numerical value comprises a Personal Identification Number (PIN) associated with the user or the payment device.

Clause 20. The method of any of clauses 13-19, wherein the numerical value is derived based on counting a timing of the pattern.

Clause 21. An authentication method, including: receiving, with at least one processor from a vaporization device, at least one pattern representing a plurality of inputs provided to the vaporization device from a user; determining, with at least one processor, that the at least one pattern matches at least one authentication pattern associated with the user; and in response to determining that the at least one pattern matches the at least one authentication pattern, authenticating, with at least one processor, a transaction between the user and a merchant.

Clause 22. The method of clause 21, wherein the plurality of inputs comprise a plurality of tactile inputs received by a sensor arranged on the vaporization device.

Clause 23. The method of clauses 21 and 22, wherein the sensor comprises at least one of a button and a motorized projection.

Clause 24. An authentication method, including: detecting, with at least one sensor arranged in a vaporization device, a plurality of inputs in at least one pattern; and communicating, from the vaporization device, authentication data representing the at least one pattern to an authenticating system.

Clause 25. The method of clause 24, wherein the plurality of inputs comprise a plurality of tactile inputs received by a sensor arranged on the vaporization device, the sensor comprising at least one of a button and a motorized projection.

Clause 26. A vaporization device, including: a mouthpiece; at least one sensor configured to detect a plurality of inputs provided to the mouthpiece; at least one controller in communication with the at least one sensor, the at least one controller programmed and/or configured to: communicate with a merchant system and/or a transaction processing system; and based on data received from the merchant system and/or the transaction processing system, prompt a user of the vaporization device to input the plurality of inputs to the vaporization device.

Clause 27. The vaporization device of clause 26, further comprising at least one indicator, wherein the user is prompted with the at least one indicator.

Clause 28. The vaporization device of clauses 26 and 27, wherein the at least one indicator comprises at least one of the following: a visual indicator arranged on the vaporization device, a mobile device associated with the user, a graphical user interface on a mobile device associated with the user, or any combination thereof.

Clause 29. The vaporization device of any of clauses 26-28, wherein the plurality of inputs comprise a plurality of tactile inputs, and wherein the sensor comprises at least one of a button and a motorized projection.

These and other features and characteristics of the disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 illustrates a schematic diagram of a system for authentication using a vaporization device according to a non-limiting embodiment or aspect;

FIG. 2 illustrates a vaporization device according to a non-limiting embodiment or aspect; and

FIG. 3 illustrates a flow diagram of an authentication method according to a non-limiting embodiment or aspect.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments as they are oriented in the drawing figures. However, it is to be understood that non-limiting embodiments may assume various alternative variations and step sequences, except where expressly specified to the contrary. It is also to be understood that the specific devices and processes illustrated in the attached drawings, and described in the following specification, are simply exemplary embodiments. Hence, specific dimensions and other physical characteristics related to the embodiments disclosed herein are not to be considered as limiting.

As used herein, the terms “communication” and “communicate” refer to the receipt, transmission, or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. It will be appreciated that numerous arrangements are possible. Any known electronic communication protocols and/or algorithms may be used such as, for example, TCP/IP (including HTTP and other protocols), WLAN (including 802.11 and other radio frequency-based protocols and methods), analog transmissions, cellular networks (e.g., Global System for Mobile Communications (GSM), Code Division Multiple Access (CDMA), Long-Term Evolution (LTE), Worldwide Interoperability for Microwave Access (WiMAX), etc.), and/or the like.

As used herein, the term “mobile device” may refer to one or more portable electronic devices configured to communicate with one or more networks and/or other devices. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices.

As used herein, the term “computing device” may refer to one or more electronic devices that include one or more processors and are configured to process data. The computing device may be a mobile device. The computing device may be a desktop computer or other non-mobile computer. Furthermore, the term “computer” may refer to any computing device that includes components to receive, process, and/or output data, and may in non-limiting embodiments include a display, a processor, a memory, an input device, and a network interface. An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications, a token service executing one or more software applications, and/or the like. A transaction processing server may include one or more processors and, in some non-limiting embodiments, may be operated by or on behalf of a transaction service provider. A token service may include one or more computer systems and/or applications for generating tokens corresponding to user accounts issued by one or more issuer institutions.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., POS devices, directly or indirectly communicating in the network environment may constitute a “system,” such as a merchant's POS system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “breathing device” may refer to any device that includes one or more sensors for detecting breaths (e.g., inhalations or exhalations). A breathing device may be specifically purposed for authenticating a user or, in other examples, may be used for one or more additional purposes. For example, a breathing device may include a vaporization device that produces vapor of one or more substances, including but not limited to a nebulization device, an atomization device, a heat-based vaporization device, and/or the like. A vaporization device may be disposable or refillable and, in some examples, may include electronic cigarettes.

In some non-limiting embodiments or aspects, the present disclosure include systems, methods, and devices that enable the user of a vaporization device or other breathing device to authenticate himself/herself. For example, in some non-limiting embodiments or aspects, the user establishes an authentication account via a website and/or mobile application and associates a specific breathing device with the account. The user may also associate data with the account, which may include billing information, shipping information, product preferences, and/or a shopping list. Using at least one sensor arranged in the device, the breathing device is configured to detect a plurality of breaths that the user inhales from and/or exhales into the device. This plurality of breaths represents a unique pattern, which is used as authentication data by the breathing device and/or one or more authenticating systems. Thus, a unique pattern of breaths may be used to authenticate the user, in addition to or alternative to other credentials such as a PIN or password, without exposing the pattern or code to observers. Using a unique arrangement of a specially-configured breathing device, software, and integration into a payment network, non-limiting embodiments provide for a new, secure way for users to authenticate themselves for conducting payments.

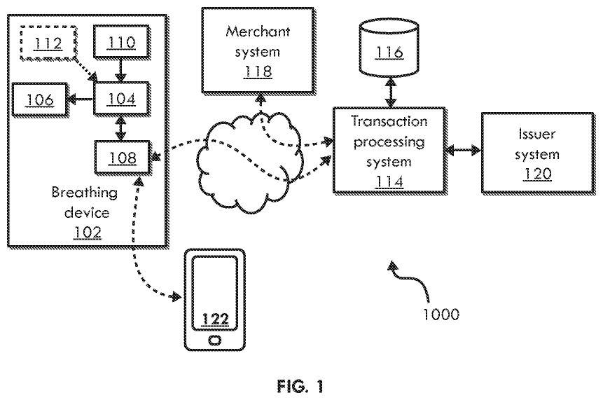

FIG. 1 shows an authentication system 1000 according to a non-limiting embodiment or aspect. The authentication system includes a breathing device 102, which includes a sensor 110, a controller 104, and a communication interface 108. The sensor 110 may be arranged in the breathing device 102 downstream from or within a mouthpiece, and is configured to detect a plurality of breaths that a user inhales from and/or exhales into the breathing device 102. The sensor 110 may be configured to detect the presence or absence of breaths, the length of breaths, the strength of breaths, and/or the like. The sensor 110 is also in communication with the controller 104, which may include a microprocessor. In some non-limiting embodiments or aspects, one or more additional sensors 112 may be used to enhance accuracy, improve security, and/or improve the user experience. For example, for breathing devices in which a sensor 110 is used to trigger a heating element (e.g., such as some vaporization devices), a separate sensor may be utilized such that the sensor 110 can be deactivated so as to not vaporize any substances while authenticating. It will be appreciated that various arrangements of sensor(s) are possible.

With continued reference to FIG. 1, upon initiating and/or registering the breathing device 102, the user inputs a desired plurality of breaths representing an authentication pattern, which is stored in a database 116 of the transaction processing system 114, merchant system 118, issuer system 120, or some other authenticating system used to authenticate the user. The stored pattern may be used as a benchmark for authentication requests. This plurality of breaths may include an intentional sequence of breaths, such as a user-specified pattern, and/or the natural breaths and/or breathing patterns a user inhales or exhales while using the vaporization device 102. For example, in some non-limiting embodiments, the database 116 may store a user-specified pattern of breaths, such as an exhalation for 3 seconds, a pause, an exhalation for 5 seconds, a pause, an exhalation of 2 seconds, a pause, and an exhalation of 3 seconds. In other examples, the pattern of breaths may be a sequence of long and short breaths, a sequence of breaths of any length and timed pauses, and/or the like. In further examples, the pattern of breaths may include a breathing profile that models a user's typical usage and breathing patterns. To register the one or more patterns, the breathing device 102 may communicate the patterns to the transaction processing system 114 or to another authentication system as raw authentication data, as processed authentication data (e.g., a numerical or alphanumerical representation of the pattern), and/or the like.

Still referring to FIG. 1, the breathing device 102 may be used in an authentication mode. For example, to authenticate a transaction being conducted with a merchant system 118, such as a merchant POS system, the user breathes a plurality of breaths into the breathing device 102, which the sensor 110 detects and communicates to the controller 104. The communication interface 108 communicates the authentication data, which may include processed sensor data and/or unprocessed sensor data, to an authenticating system via a wireless communication network. In some non-limiting embodiments, the authentication data may be communicated to the merchant system 118, transaction processing system 114, and/or other authenticating systems via one or more mobile devices 122 in communication with the breathing device 102. As an example, in a scenario in which a user conducts a transaction using a mobile device 122 as a payment device, the user may be prompted to authenticate himself or herself in various ways, including a biometric input provided to the mobile device 122, a PIN or password inputted to the mobile device 122, and/or inputs using the breathing device 102. In some non-limiting embodiments, the authentication data from the breathing device 102 may be communicated to the mobile device 122 via a wireless connection, such as Bluetooth®, and the mobile device 122 may communicate the authentication data to the authenticating system via a wireless connection, such as Bluetooth®, Near-Field Communication (NFC), Infrared Data Association (IrDA), Induction wireless, Ultra Wideband, and/or the like. The mobile device 122 may relay the authentication data from the breathing device 102 or may process the data to identify one or more patterns, thereby generating further authentication data that is recognizable by the authenticating system.

With continued reference to FIG. 1, once the merchant system 118, transaction processing system 114, and/or other authentication system receives the authentication data, the authentication data may be compared to the authentication pattern stored in the database 116 for the user and/or account identifier. In non-limiting embodiments in which unprocessed sensor data is communicated as authentication data, the authenticating system may process the authentication data. The transaction processing system 114 or some other authenticating system may compare the authentication data to the authentication pattern stored in the database 116. If the authenticating system determines that the input pattern exceeds a minimum confidence threshold and therefore sufficiently matches the pattern represented by the authentication data, the user is authenticated. If a minimum confidence threshold is not exceeded, the user is not authenticated, the authenticating system instructs the transaction processing system 114 to not process the transaction (e.g., in examples in which the transaction processing system 114 is not the authenticating system), and the authenticating system will communicate data to the breathing device 102 and/or mobile device 122, such as a notification or a prompt to repeat the input.

Still referring to FIG. 1, in non-limiting embodiments or aspects, the communication interface 108 of the breathing device 102 may receive data from the merchant system 118, the transaction processing system 114, and/or some other authentication system. The vaporization device 102 may further include an indicator 106 configured to communicate with the user based on data received from the authentication system and/or the vaporization device 102 itself. For example, the indicator 106 may notify the user that an authentication mode has been initiated, prompt the user to input a plurality of breaths, confirm that the user has been authenticated, and/or alert the user to the status of the vaporization device or vaporizer cartridge. Although the indicator 106 may be visual, such as one or more lights arranged on the outside of the vaporization device 102 and/or one or more display screens, other means of indication are possible, such as audible and haptic notifications. One or more graphical user interfaces generated and displayed on the user's mobile device 122 may also be used as an indicator. Similarly, a combination of indicators may be used to enhance communication between the vaporization device 102 and the user.

With continued reference to FIG. 1, in some non-limiting embodiments or aspects, a biometric sensor 112 may be used to initially and/or further authenticate the user. This biometric sensor 112 may be used either in conjunction with or exclusive to a sensor 110 configured to detect a plurality of breaths. If the vaporization device 102 is configured with a biometric sensor 112 as well as a sensor 110 configured to detect a plurality of breaths, one sensor may provide a second factor authentication for the other. For example, if the biometric sensor 112 receives a biometric input from the user, and the controller 104 or an authenticating system determines that the user is not authenticated based on the biometric input alone, the user may be further prompted via the indicator 106 and/or mobile device 122 to provide a plurality of breaths to the breathing device 102 to be detected by the sensor 110. Non-limiting examples of the biometric input received by the biometric sensor 112 include a scan of the user's lips, a scan of the user's tongue, a pattern of use of the vaporization device (e.g., a breathing profile that models a user's typical usage and breathing patterns), a fingerprint (e.g., through a fingerprint scanner on the breathing device 102 or mobile device 122), and/or other like biometric inputs.

In non-limiting embodiments or aspects, a second authentication may be performed in response to determining that a match has not been made within the minimum confidence threshold. For example, the controller 104 may perform a second authentication by communicating a limited use key (e.g., such as a temporary PIN or code) via electronic mail, short message service (SMS), push notification, and/or the like, which may be inputted via the user's mobile device 122.

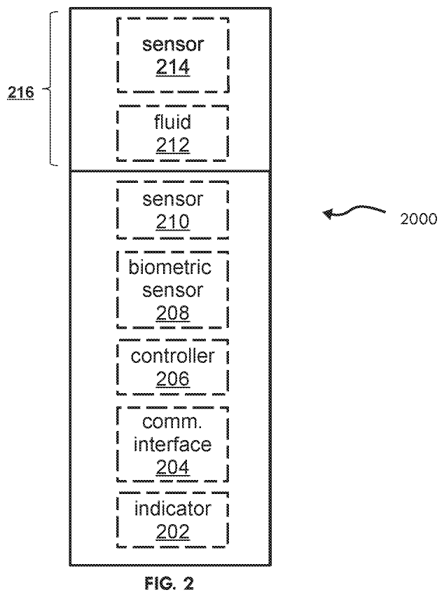

FIG. 2 shows a vaporization device 2000 according to a non-limiting embodiment or aspect of the present disclosure. The vaporization device 2000, as depicted in this non-limiting example, includes a mouthpiece 216, at least one sensor 210, at least one controller 206, and a communication interface 204. The sensor 210 is configured to detect a plurality of breaths inhaled from and/or exhaled into the mouthpiece 216. The controller 206 may be in communication with the at least one sensor 210, such that it may represent a pattern of the plurality of breaths as authentication data. The controller 206 is in further communication with the communication interface 204, such that the controller 206 may communicate authentication data to a remote system or device, such as a transaction processing system, a merchant system, a mobile device, or any authenticating system. Such communication may be wirelessly performed by a communication interface 204, or through a user's mobile device in local communication with the vaporization device 2000.

With continued reference to FIG. 2, the controller 206 may be configured to receive data from a transaction processing system, merchant system, issuer system, or other authenticating system. Based on data received from an authentication system, for example, the controller 206 may further prompt the user to take an additional action. For example, if the authentication system requests authentication to authorize a transaction, the controller 206 may initiate an authentication mode of the vaporization device 2000 and thereby prompt the user to input a plurality of breaths into the vaporization device 2000. The controller 206 may then represent the plurality of breaths as authentication data and communicate the authentication data back to the authentication system.

As shown in the non-limiting example of FIG. 2, the sensor 210, controller 206, and communication interface 204 may be arranged in the vaporization device 2000 downstream from the mouthpiece 216. However, some vaporization devices 2000 may be configured with a removable mouthpiece 216 in which a fluid 212 is contained, consumed, and subsequently replaced. Thus, alternative arrangements and sequences are further contemplated by the present disclosure to accommodate for the specific design of the vaporization device 2000. For example, in non-limiting embodiments or aspects, the sensor 210, controller 206, and communication interface 204 may be arranged in the mouthpiece 216 of the vaporization device 2000 in any order.

Still referring to FIG. 2, in non-limiting embodiments or aspects the vaporization device 2000 includes a biometric sensor 208 to authenticate the user. This biometric sensor 208 may be arranged on an exterior surface of the vaporization device 2000, such as on a button of the vaporization device 2000 or on another part of a housing of the vaporization device 2000. The biometric sensor 208 may be used as an initial, secondary, or alternative authentication mechanism.

With reference to the example vaporization device 2000 shown in FIG. 2, in non-limiting embodiments or aspects the vaporization device 2000 includes at least one indicator 202 configured to prompt the user based on data received from the transaction processing system, merchant system, issuer system, and/or other authenticating system. The indicator 202 may be a visual indicator, such as one or more light emitting diodes (LEDs) or other small lights arranged on an exterior of the vaporization device 2000. In non-limiting embodiments, the indicator 202 may be a display device, a speaker for making audible notifications, a motor for providing haptic notifications, and/or the like. Similarly, an arrangement of one or more indicators may be used to enhance communication between the vaporization device 2000 and the user.

In non-limiting embodiments or aspects, the vaporization device 2000 includes a second sensor 214 arranged on the vaporization device 2000, such as on the mouthpiece 216, and configured to detect a physical input. The sensor 214 may include a button, a motorized projection, a capacitive sensor, and/or the like, configured to be make contact with the user's mouth. The sensor 214 may be used by a user to input a pattern of contacts. As an example, a user may press the sensor 214 with his or her tongue while the mouthpiece 216 is between the user's lips. The user may input a sequence of inputs to the sensor using his or her tongue, lips, and/or the like.

In non-limiting embodiments in which the sensor 214 is a motorized projection, the authentication mode may cause the motor to advance the projection away from the mouthpiece 216 and towards the user's mouth a specified distance, after which the motor retracts the projection back into the mouthpiece 216. The advancement and retraction of the projection may constitute a cyclical motion, and the cyclical motions may occur at random intervals. The sensor 214 and controller 206 may be configured to register each cyclical motion as one count. The sensor 214 may be further configured to detect when the user opens their mouth and will subsequently commence a new count. The user may feel the projection advance, keep track of the count, and provide a tactile input upon the count associated with a corresponding number of the pattern. Tactile inputs may include, for example, slightly opening the user's mouth, touching the projection with the user's tongue, pressing the projection with the user's tongue, and/or the like. Upon detecting the tactile input, the sensor 214 may commence a new count. This process will repeat until the entire pattern has been input by the user and detected by the sensor. Using a sensor 214 this way enhances the security of the authentication process because the inputs are naturally shielded by the user's mouth. The user's pattern (e.g., potentially representing a secret PIN) is further protected because the cyclical motions occur at random intervals, thus convoluting and/or obscuring any visible motions of the user's lips, tongue or mouth.

For example, if a user's PIN is 1-4-2-3, the user may open his mouth after feeling the projection touch his lip one time, after which there will be a brief pause. After the cyclical motion begins again, the user might open his mouth after feeling the projection touch his lip four times, after which there will be a brief pause. Upon inputting all digits of the PIN in this manner, the user may press a button signaling completion or the controller may determine that a maximum number of inputs have been provided. Alternatively, the sensor 214 may be configured to register a count beginning at a non-zero number to enhance security or provide the user with tactile notice that the authentication mode has commenced and inputs will be required. Once the controller 206 receives the complete pattern from the sensor 214, it communicates the pattern as authentication data via the communication interface 204 or a mobile device associated with the user.

In non-limiting embodiments, the sensor 214 may include or be associated with a button, which may be used to reset the cyclical motion of the sensor 214, re-initiate the authentication mode, and/or enable the user to reenter the desired pattern. The sensor 214 may be used as a primary means of authentication or may supplement the sensor 210 configured to detect a plurality of breaths as a second factor authentication where, for example, the minimum confidence threshold is not satisfied.

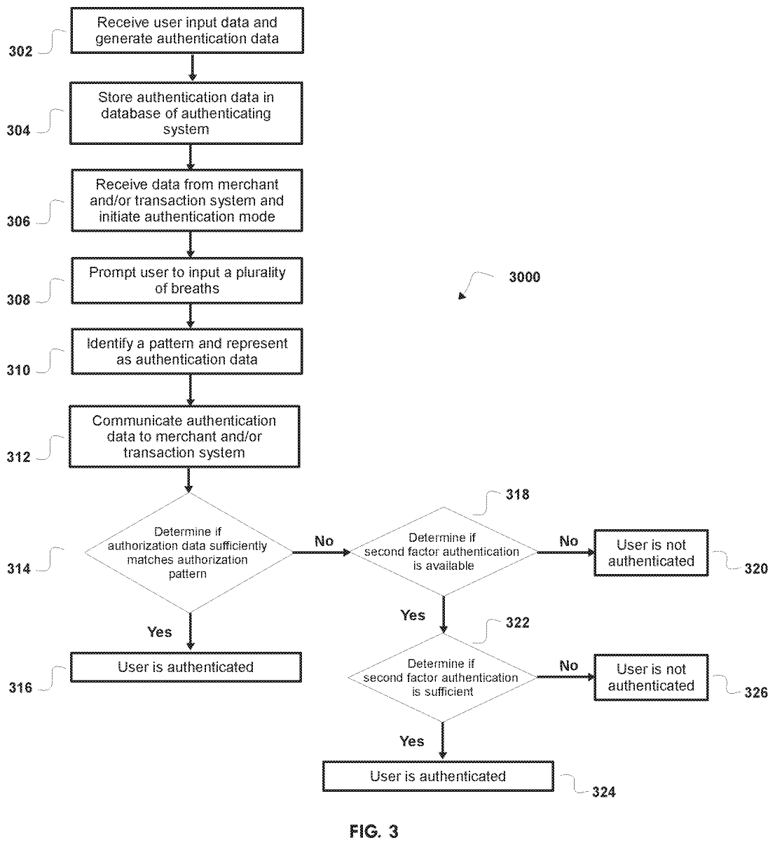

FIG. 3 shows a process of authentication using a breathing device 3000 according to a non-limiting embodiment or aspect. At step 302, the vaporization device receives a plurality of breaths from the user and, based on the input, generates authentication data, such as an authentication pattern. The vaporization device may receive a biometric input and/or a tactile input in other non-limiting embodiments, instead of or in addition to receiving the plurality of breaths, which it uses to create an authentication pattern. At step 304, the authentication data is stored in a database of the authenticating system, such as the transaction processing system.

With continued reference to FIG. 3, at step 306, the vaporization device may receive data from a transaction processing system, a merchant system, or another authenticating system, such as an authentication request, in response to which it initiates an authentication mode. In authentication mode, at step 308, the vaporization device prompts the user to provide a plurality of breaths and/or another authenticating input, such as a biometric or tactile input. In some non-limiting embodiments or aspects, the breathing device includes an indicator which prompts the user via visual, audible, and/or haptic feedback. The vaporization device identifies a pattern of breaths from the input received from the user at step 310, and communicates the pattern as authentication data to the transaction processing system, merchant system, or other authenticating system at step 312. The authentication data is compared to the stored authentication data, and the authenticating system determines if it matches at step 314. If there is a match, which may be an exact match or a match within a confidence threshold, the user is authenticated and the transaction is processed at step 316.

Still referring to FIG. 3, if there is not a sufficient match at step 314, the transaction processing system, merchant system, or other authenticating system determines if a second and/or alternative authentication is available at step 318. If another authentication method is not available, the user is not authenticated at step 320 and the transaction is denied. If another authentication method is available, the vaporization device receives data from the transaction processing system, merchant system, or other authenticating system and re-initiates an authentication mode at step 322. The vaporization device again prompts the user for a second input, which may be the same or different type of input from the initial input received. The second input may include a plurality of breaths, a biometric input, or a tactile input 322. The vaporization device identifies a pattern from the second input and communicates it back to the transaction processing system, merchant system, or other authenticating system as authentication data 322. The authenticating system once again determines if the authentication data is a match to stored authentication data at step 322. If there is a sufficient match, the user is authenticated and the transaction is processed at step 324. If there is not a sufficient match, the user is not authenticated at step 326 and the transaction is denied.

Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment or aspect.

What is claimed is:

1. An authentication method, comprising:
detecting, with at least one sensor arranged in a vaporization device, a plurality of breaths inhaled from and/or exhaled into the vaporization device, the plurality of breaths in at least one pattern; and
communicating, from the vaporization device, authentication data representing the at least one pattern to an authentication system.

2. The authentication method of claim 1, further comprising:
receiving, with a controller arranged in the vaporization device, data from at least one of the merchant system and the transaction processing system; and
prompting, with an indicator arranged on the vaporization device, a user of the vaporization device to input the plurality of breaths to the vaporization device in response to receiving the data from the authentication system.

3. The authentication method of claim 1, further comprising:
receiving, with a controller arranged in the vaporization device, data from the authentication system;
initiating, with the controller, an authentication mode of the vaporization device; and
in response to initiating the authentication mode, detecting the plurality of breaths.

4. The authentication method of claim 1, further comprising:
receiving, with a controller arranged in the vaporization device, at least one biometric input from the user; and
determining, with the controller, that the user is not authenticated based at least partially on the at least one biometric input,
wherein the user is prompted to provide the plurality of breaths in response to determining that the user is not authenticated.

5. The authentication method of claim 4, wherein the biometric input comprises at least one of the following: a pattern of use of the vaporization device, a scan of the user's lips, a scan of the user's tongue, or any combination thereof.

6. The authentication method of claim 1, further comprising:
determining, with a controller arranged in the vaporization device, that the at least one pattern matches at least one authentication pattern associated with the user or a payment device; and
generating, with the controller, the authentication data in response to determining that the at least one pattern matches the at least one authentication pattern.

7. The authentication method of claim 1, wherein the authentication data is communicated to the authentication system via a mobile device in localized communication with the vaporization device.

8. A vaporization device, comprising:
a mouthpiece;
at least one sensor configured to detect a plurality of breaths inhaled from and/or exhaled into the mouthpiece; and
at least one controller in communication with the at least one sensor, the at least one controller programmed and/or configured to: communicate with an authentication system; and based on data received from the authentication system, prompt a user of the vaporization device to input the plurality of breaths to the vaporization device.

9. The vaporization device of claim 8, further comprising at least one indicator, wherein the user is prompted with the at least one indicator.

10. The vaporization device of claim 9, wherein the at least one indicator comprises at least one of the following: a visual indicator arranged on the vaporization device, a mobile device associated with the user, a graphical user interface on a mobile device associated with the user, or any combination thereof.

11. The vaporization device of claim 8, wherein the at least one controller is further programmed and/or configured to: in response to receiving data from the authentication system, initiating an authentication mode.

12. The vaporization device of claim 11, wherein the at least one controller is further programmed and/or configured to: detect the plurality of breaths in response to initiating the authentication mode.

13. An authentication method, comprising:
detecting, with at least one sensor arranged in a vaporization device, a plurality of breaths from a user, the plurality of breaths comprising at least one pattern;
determining, with at least one processor, that the at least one pattern matches at least one authentication pattern associated with the user or a payment device; and
in response to determining that the at least one pattern matches the at least one authentication pattern, authenticating, with at least one processor, a transaction between the user and a merchant.

14. The authentication method of claim 13, further comprising:
receiving, from a merchant system, a request to conduct the transaction;
receiving, from the vaporization device, at least one biometric input associated with the user;
determining, with at least one processor, that the transaction or the user is not authenticated based on the at least one biometric input; and
in response to determining that the transaction or the user is not authenticated based on the at least one biometric input, prompting, with at least one processor, the user to provide the plurality of breaths.

15. The authentication method of claim 13, wherein the biometric input comprises at least one of the following: a pattern of use of the vaporization device, a scan of the user's lips, a scan of the user's tongue, or any combination thereof.

16. The authentication method of claim 13, wherein the plurality of breaths comprise at least one of inhalation and exhalation.

17. The authentication method of claim 13, wherein the at least one pattern comprises a series of breaths and pauses.

18. The authentication method of claim 13, further comprising deriving a numerical value from the at least one pattern.

19. The authentication method of claim 18, wherein the numerical value comprises a Personal Identification Number (PIN) associated with the user or the payment device.

20. The authentication method of claim 18, wherein the numerical value is derived based on counting a timing of the pattern.
